(19) United States
(12) Patent Application Publication
(10) Pub. No.: US 2006/0269061 A1
(43) Pub. Date: Nov. 30, 2006

(54) MOBILE DEVICE AND METHOD FOR DISPENSING AUTHENTICATION CODES

(75) Inventors: Chandra Balasubramanian, Lakewood, OH (US); Francis Sherwin, Cleveland Heights, OH (US); Michael A. Keresman III, Kirtland Hills, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: CardinalCommerce Corporation, Mentor, OH (US)

(21) Appl. No.: 11/381,270

(22) Filed: May 2, 2006

Related U.S. Application Data
(63) Continuation-in-part of application No. 10/044,630, filed on Jan. 11, 2002.
(60) Provisional application No. 60/261,051, filed on Jan. 11, 2001.

(51) Int. Cl. H04K 1/00

(52) U.S. Cl. 380/247; 340/5.61; 705/67

(57) ABSTRACT

A method for provisioning a mobile device (100) with a personalized authorization code generating application (101) includes: collecting user information and a password; generating an application specific encryption key (128) from the collected user information and the password; embedding the generated application specific encryption key (128) in a software code (130) provisioned to generate authorization codes using the application specific encryption key (128) in accordance with a prescribed algorithm, the software code with the application specific encryption key embedded therein comprising the personalized authorization code generating application; and, delivering the personalized authorization code generating application (101) to the mobile device (100).

The present application is a continuation-in-part application of U.S. patent application Ser. No. 10/044,630, filed Jan. 11, 2002, which claims the benefit of Provisional U.S. Patent Application No. 60/261,051, filed Jan. 11, 2001, both of which are incorporated by reference herein in their entirety.

### BACKGROUND

The present inventive subject matter related generally to identity authentication. More specifically, it is directed to the generation and dispensing of unique, random numbers or one-time-use authentication codes or passwords that are used for a variety of transactional applications and, in particular, to applications using these numbers, codes or passwords for authentication purposes. It finds suitable application in conjunction with both network based and, more traditional, face-to-face transactions. However, it is to be appreciated that the present inventive subject matter is amenable to a variety of different applications.

One type of network transaction is Internet commerce. Other applications include voting online, accessing medical records, interacting with the government, etc. A common desire for all of these applications is a reliable method for authenticating the user in order to prevent fraud and/or unauthorized access to sensitive or important data.

Internet commerce, or e-commerce as it is otherwise known, relates to the buying and selling of products and services by buyers and sellers over the Internet or the transactional exchange of information. The convenience of shopping over the Internet has sparked considerable interest in e-commerce on behalf of both buyers and sellers. Internet sales, or like transactions, have been typically carried out using standard credit or debit cards such as Visa®, MasterCard®, Discover®, American Express®, or the like. However, while widely used for more traditional face-to-face transactions, use of these standard credit or debit cards in connection with e-commerce presents certain difficulties. For example, maintaining buyer confidence and security has become difficult with increased reports of credit card fraud. The resulting apprehension is also fueled by buyer uncertainty of the reputation or integrity of a seller with whom the buyer is dealing. The security of the buyer's credit card information or other personal information (e.g., address, credit card number, phone number, etc.) typically submitted along with a traditional Internet credit card transaction serves to increase the apprehension even more. Additionally, credit card account holders, sellers and financial institutions are concerned about safeguarding against fraudulent or otherwise unauthorized credit card transactions.

It would be desirable, therefore, to provide a new method for carrying out authenticated credit or debit card transactions in particular, and any transaction requiring authentication in general, over the Internet and in the face-to-face world that overcomes the above-described problems.

### SUMMARY

In accordance with one embodiment, method for provisioning a mobile device with a personalized authorization code generating application includes: collecting user information and a password; generating an application specific encryption key from the collected user information and the password; embedding the generated application specific encryption key in a software code provisioned to generate authorization codes using the application specific encryption key in accordance with a prescribed algorithm, the software code with the application specific encryption key embedded therein comprising the personalized authorization code generating application; and, delivering the personalized authorization code generating application to the mobile device.

In accordance with another embodiment, a system for provisioning a mobile device with a personalized authorization code generating application includes: data collection means for collecting user information and a password; key generation means for generating an application specific encryption key from the collected user information and the password; merging means for embedding the generated application specific encryption key in a software code provisioned to generate authorization codes using the application specific encryption key in accordance with a prescribed algorithm, the software code with the application specific encryption key embedded therein comprising the personalized authorization code generating application; and, delivery means for delivering the personalized authorization code generating application to the mobile device.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1A is a diagrammatic illustration showing a front side of an exemplary authentication token embodiment aspects of the present inventive subject matter.

FIG. 1B is a diagrammatic illustration showing an exemplary back side and internal memory of the token depicted in FIG. 1.

FIG. 2 is a flow diagram showing an exemplary method of programming a token with authentication codes.

FIG. 3 is a flow diagram showing an exemplary method of dispensing authentication codes from a token.

FIG. 4 is a flow diagram showing an exemplary method of user authentication suitable for implementation in accordance with the present inventive subject matter.

FIG. 5 is a flow diagram showing an exemplary method of synchronizing an authentication code database and a token.

FIG. 6 a diagrammatic illustration showing a front side of an exemplary alternative embodiment of the token depicted in FIG. 1.

FIG. 7 is a diagrammatic illustration showing an exemplary system for provisioning a mobile station with a personalized mobile authentication application that dispenses one-time-use or limited-used authentication codes.

FIG. 8 is a flow diagram showing a process carried out by the hardware security module depicted in FIG. 7.

### DETAILED DESCRIPTION OF PREFERRED EMBODIMENTS

For clarity and simplicity, the present specification shall refer to structural and/or functional elements, entities and/or facilities, relevant standards, protocols and/or services, and other components and features that are commonly known in the art without further detailed explanation as to their configuration or operation except to the extent they have been modified or altered in accordance with and/or to accommodate the embodiment(s) presented herein.

In accordance with one aspect of the present inventive subject matter, a method is provided for conducting a commercial transaction over a telecommunications network, such as the Internet or other network connection. Suitably, the method includes the use of random numbers (e.g., non-predictable numbers that are not deliberately mathematically related to any other number generated or dispensed by the device) or one-time-use or limited-use alphanumeric authentication codes or passwords.

In one suitable embodiment, the codes are pre-loaded onto a handheld, portable device, hereinafter referred to as a token, at the time of the token's manufacture or by programming the token at a later time over a network connection. In alternate embodiments, the codes are pre-loaded onto other devices, e.g., such as personal computers (PCs), notebook computers, handheld computers, personal data assistants (PDAs), web pads, net appliances, cell phones, etc. Suitably, the codes are generated by external systems (computer systems or other random number generating devices). The external systems then deliver the sets of codes to the token for storage in the token's internal memory and also to another database that is accessible by an authentication system, serving as an authentication agent, which may optionally be the same system as the code generating system. In an alternate embodiment, the token is programmed or provisioned with a personalized code generating application that produces the codes on periodic or as-needed basis.

In one suitable embodiment, the codes are dispensed by the token to a user upon demand. The user requests a code to be dispensed by pressing a button on the token or otherwise signaling the token. In order to increase the number of codes that are available in the token, one or more simple polynomial equations may be employed as transformation functions, producing additional codes from each stored code. For example, each stored code can be first transformed by a first polynomial equation, and the transformation result dispensed to the user. A subsequent user request for a code can cause the untransformed code to be dispensed. This method doubles the number of codes available on the token. If polynomial transformations are implemented, each code can be transformed by 1 to N polynomial equations, effectively increasing the number of available codes by a factor of N+1. A dispensed code is cross referenced, by the authentication system, to the code database that was created when the token was programmed. In this way the user or transaction can be authenticated.

It is intended, in a preferred configuration, that once the total number of code combinations, e.g., including the original codes and codes generated by polynomial transformations, have been exhausted, the token becomes inoperable. Optionally, the token may be reloaded with a new set of codes. Alternately, of course, in the case of tokens provisioned with personalized code generating applications, the number of codes which the token is able to dispensed is indefinite, at least theoretically.

The token can take on any form suitable for a given application. For example, the token can be a small handheld device similar to a small calculator. In a one suitable embodiment, however, the token takes on the form of a credit card, debit card or similar card. This form is essentially the size of a traditional credit card in width, height and thickness. The token is, optionally, solar powered and has internal magnetic transducers that allow the token to emulate a credit card magnetic strip. This allows the token to be used for face-to-face transactions that traditionally use a magnetic card reader. Other physical devices that are optionally employed include, but are not limited to, wrist watches, cellular or mobile telephones or other wireless telecommunication devices, such as PDAs or laptop computers, key chain fobs, etc. The token can, therefore, be used for multiple types of transactions such as, for example, debit transactions, accessing credit lines, accessing personal records, etc.

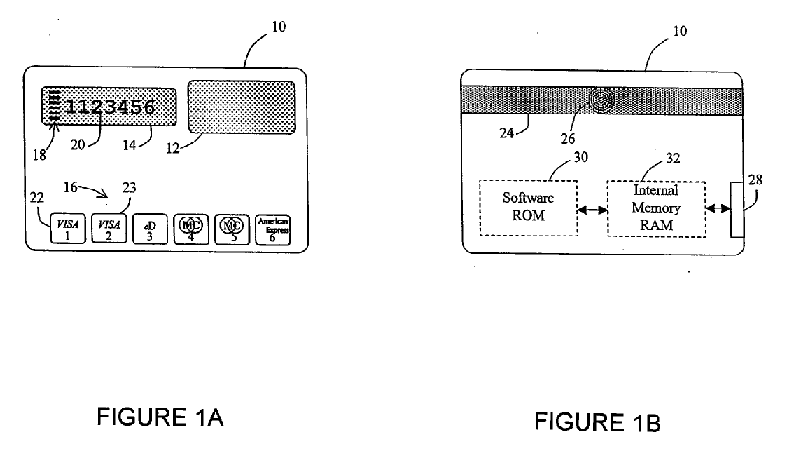

With reference to FIG. 1A, the front side of a token 10 is shown. Visible on the front side of the token 10 are a power source 12, a display area 14 and buttons 16. Included in the display area 14 are a status indicator 18 and a dispensed code 20. In a preferred embodiment, each of the buttons 16 is used to select an account and request that the token 10 dispense a code from its internal memory. For example, a first button 22 is configured to select a first Visa® account. Upon detecting a selection of the first button, software in the token selects the next available authentication code from its internally stored codes, “123456” for example, causes an account code representing the selected Visa® account to be displayed, “1” for example, combined with the selected authentication code in the display area 14, “1123456” in this example, and deletes the selected authentication code from its internal memory or, alternately, advances a pointer to the next available authentication code. In either case, only unused authentication codes remain available for succeeding selections of the buttons 16.

If, as an alternate example, a second button 23 is selected, a different account code representing a second Visa® account, “2” for example, is combined with the selected authentication code in the display area 14, “2123456” in this alternate example. Suitably, each of the buttons 16 has a unique account code assignment depicting a type of account as illustrated in the previous example. Optionally, the account code representing the selected account may be a prefix as in the aforementioned example or, alternately, the account code may be displayed as a suffix, or as an intermediate portion, of the dispensed code 20. Alternately, the selected authentication code can be prefixed or suffixed to the user's account number, or other account identification. In yet another embodiment, the selected authentication code may be displayed by itself. In one suitable embodiment, the status indicator 18, configured as a bar graph in this example, is updated to indicate visually the quantity of authentication codes remaining in the token.

In a suitable embodiment, one table of numbers is programmed and shared by all of the buttons 16 and the bar graph status indicator 18 provides an indication of the total quantity of codes remaining in an internal memory 32. When the token 10 is initially programmed with a set of authentication codes, the bar graph is displayed at a maximum height as illustrated in FIG. 1A. As the internal memory 32 becomes depleted of codes after each use of the token 10, the bar graph becomes shorter in proportion to the percentage of originally programmed codes remaining. If, however, multiple tables or sets of codes are programmed into the memory 32, one table or set for each of the buttons 16 for example, the token 10 is configured to display a bar graph indicative of the percentage of authentication codes remaining for the most recently selected button.

While FIG. 1A is directed specifically to a physical token device, all of the features presented therein can be incorporated into a software embodiment for use on interactive devices capable of displaying a graphical representation of FIG. 1A on a graphical display screen, wherein physical buttons are replaced by virtual buttons. For example, a software application can simulate the token 10 with a graphical likeness of the token, wherein a pointing device such as a mouse is used to select one of the buttons 16. Similarly, notebook computers, handheld computers, PDAs, web pads, net appliances and cell phones with GUI capabilities can incorporate software embodiments of the token 10.

Optionally, cell phones that have only a text capable display screen can, however, still simulate the features of the token 10 with a text based interface. For example, the cell phone optionally displays text lines representing each of buttons 16, wherein each text line also displays a number associated with each button. A user then uses the cell phone keypad to select one of the buttons by entering the number corresponding to the desired button.

In FIG. 1B, with continuing reference to FIG. 1A, the back side of the token 10 is shown. Visible on the back side of the token are a simulated magnetic strip 24 which serves as an aid in orienting the token correctly for scanner devices, a magnetic transducer 26 for generating pulses suitable for reading by scanner devices, and a communications port 28 for programming the token. Also shown are an internal software memory 30 for the aforementioned software and an internal memory 32 for storing the authentication codes. In one suitable embodiment, the internal memory 32 is implemented as a non-volatile memory so that, during times when the power source 12 is not providing energy, codes are not lost from memory 32. Software memory 30 may be implemented as read-only memory (ROM) or, alternately, as a non-volatile, programmable memory.

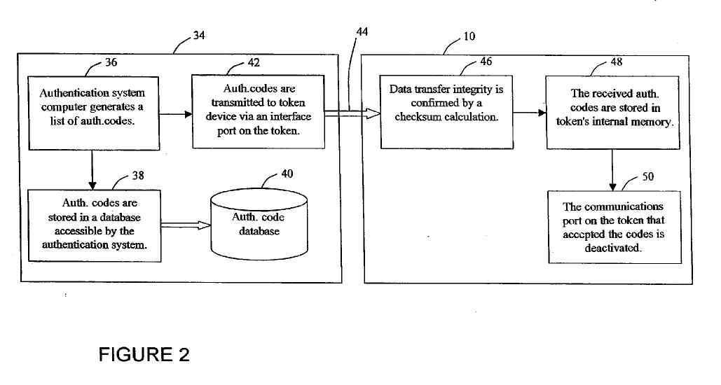

With continuing reference to FIGS. 1A and 1B, a method of programming the token 10 with a set of authentication codes is illustrated in FIG. 2. Suitably, an external authentication system 34 is configured to generate sets of authentication codes by any of a number of well known means. Within the system 34, an authentication computer 36 calculates a predetermined quantity of codes which are subsequently stored by a function 38 in an authentication code database 40. The program 42 also transmits the codes over a communications link 44 to the communications port 28 on the token 10. The software in memory 30 verifies the integrity of the code transmission with a function 46, stores the codes in the internal memory 32 with a function 48, and deactivates the communications port 28 with a function 50 to prevent alteration of the stored codes.

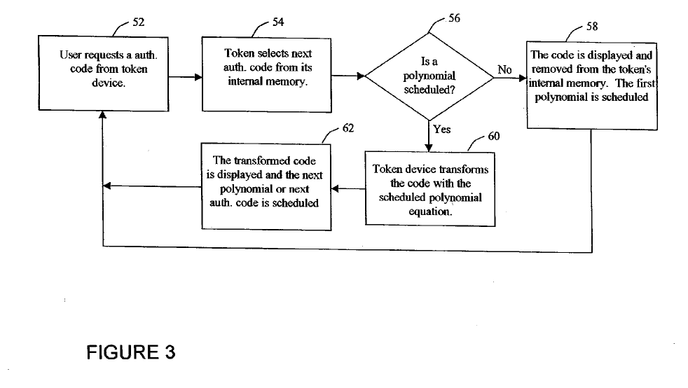

As previously mentioned, the token 10 dispenses authentication codes to a user upon demand. A method of dispensing the codes from internal memory 32 is shown in FIG. 3. The user requests a code to be dispensed by pressing one of the buttons 16 on the token at step 52. Subsequently, at step 54, the software in memory 30 selects the first available code from the internal memory 32. Because polynomial transformations are optionally employed, a decision at step 56 is made to determine if a polynomial transformation is scheduled for the currently selected code.

If there are no remaining predefined polynomial transformations to be applied to the selected code, processing continues at step 58 where the selected code is displayed in the display area 14 as the displayed code 20 and removed from the token's internal memory 32. Optionally, the displayed code 20 includes at least one indicator digit or character depicting which of the buttons 16 was selected, for example, a prefix code representing the selected Visa® account as shown in FIG. 1A. This code is used by the authentication system 34 to determine which account to use when processing the transaction. The first of the predefined polynomials is then scheduled, and processing returns to step 52 to await another user request. If a polynomial is scheduled, step 56 causes processing to continue at step 60 where software in memory 30 applies the scheduled polynomial transformation to the selected code. At step 62, the transformed code is displayed, optionally, with the aforementioned indicator digit. At step 62, the next polynomial transformation is scheduled or, if no more polynomials remain, an indicator is set to control the next execution of step 56.

It should be noted that, when polynomial transformations are implemented, the above-described method applies the polynomials to each code selected from internal memory 32 and displays the untransformed number after all transformations are applied. Software in memory 30 can, however, be configured to display the untransformed code before applying any transformations, or can also be configured to display the untransformed code at any intermediate point as well.

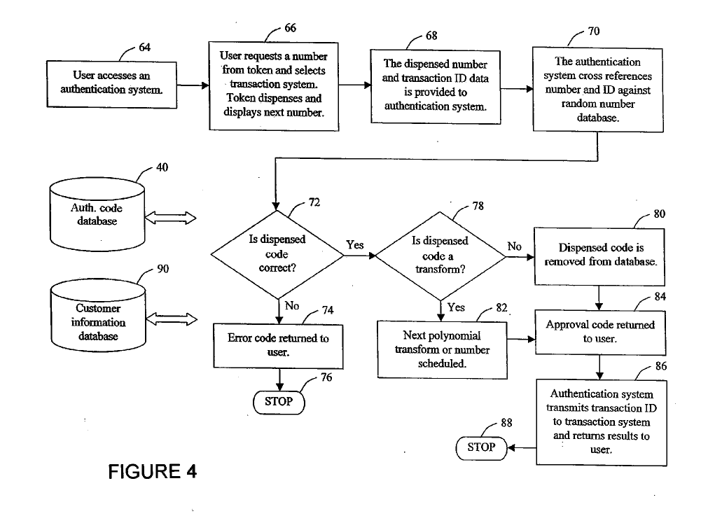

A method of processing an authenticated transaction, a credit or debit card or other purchase for example, is illustrated in FIG. 4. At step 64, a user accesses the authentication system 34 by any well known means, a dial-up Internet connection for example. The user then requests a code from the token 10 at step 66, and at step 68, the token dispenses, by the method shown in FIG. 3, a code, e.g., including an account indicator digit as previously described. The user next communicates the displayed code and other account identification data (e.g. a user ID or name) to the authentication system 34 and, at step 70, the authentication system cross references the received code and the user's ID against the authentication code database 40.

Suitably, a decision is made at step 72 as to whether the supplied code is correct or incorrect. If the code is incorrect, optionally, an error is returned to the user at step 74, and processing stops at step 76. If the supplied code is correct, that is it matches the first available code for the user in the database 40, processing continues at step 78 where it is determined if the supplied code is the result of a polynomial transformation. If the code is not the result of a transformation, the code is removed from the database 40 at step 80, otherwise, the next polynomial transformation is scheduled at step 82 in a manner equivalent to the method shown in FIG. 3. In either case, optionally, an approval code is returned to the user at step 84. Suitably, at step 86, the authentication system 34 transmits the user's account identification and card number to a transaction system associated with the above-mentioned account indicator digit.

In order to reduce, or eliminate, exposure of a user's account information to other users of a network, it is also provided that the authentication system 34 can optionally maintain the user's account numbers and validating data such as card expiration dates in a customer information database 90. A user of the authentication system 34 then is not required to submit his or her account number for each transaction. Instead, at step 86, the authentication system 34 can be configured to select the user's account information from the customer information database 90 for transmission to the selected transaction system.

To eliminate exposure of the user's account information to the network, alternate methods are optionally employed. For example, the authentication system 34 may, alternately, make any required payment, from funds available to the authentication system, to the transaction system requesting payment, thereby eliminating exposure of the user's account information to the network. In this alternate embodiment, the authentication system 34 subsequently debits the user's account directly.

Another possibility is that a user who is connected to an online merchant over the Internet will have an established account with the online merchant, and the online merchant will be connected through a secure line, such as a private leased line, to an authentication system 34 serving as an authentication agent. In this case, the online merchant will have the user's credit card or debit card account information on file and, therefore, only needs to request an authentication code from the user's token 10 for authentication purposes. The online merchant then communicates the code to the authentication agent for verifying that the connected user is the legitimate account owner. The online merchant then completes the financial transaction through a secure line, either through the authentication agent, or directly to the financial institution holding the account.

With sensitive data stored on the database 90 and not being supplied by a user over a network to the authentication system, it becomes feasible to use a simplified encryption function for submitting dispensed codes to the authentication system 34. The risk associated with theft of a transmitted code is reduced because each dispensed code is used only once or a limited number of times and becomes useless thereafter. Without exposure of the user's account information to a network connection, it is feasible to carry out a transaction on a network without encryption.

The authentication method described in FIG. 4 assumes that the token 10 remains synchronized with respect to the database 40 by deleting each number, as it is used, from the database 40 and the token's internal memory 32. It is also envisioned that synchronization may be accomplished by means of pointers in the database 40 and internal memory 32 where each pointer is incremented as each code is used. With either method of synchronization, however, it is useful to have a means of resynchronization. For example, a user may inadvertently select one of the buttons 16 causing the token 10 to dispense a code that is not needed by the user, thus causing internal memory 32 to advance one code ahead of the database 40 for each such occurrence.

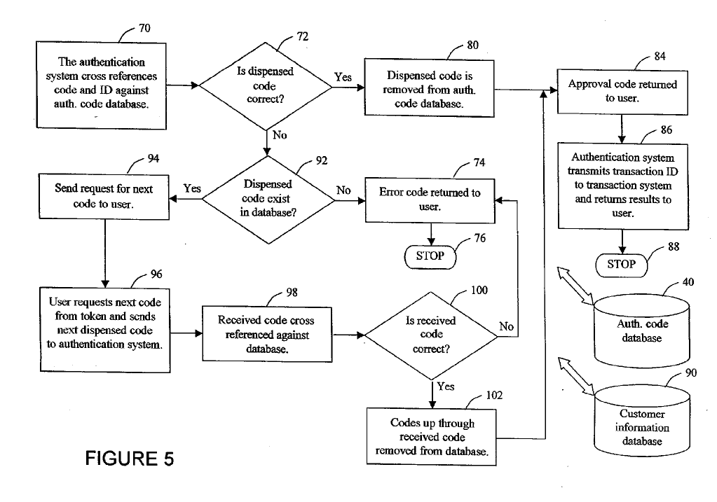

FIG. 5 shows an alteration to the method of FIG. 4 that permits resynchronization to occur. It is assumed for the sake of simplicity that no polynomial transformations are implemented in FIG. 5, however, suitable alterations to FIG. 5 are easily imagined by comparison with FIG. 4. Like numbered steps in FIG. 5 correspond to identical steps in FIG. 4. For example, FIG. 5 starts at step 70 where the authentication system cross references the supplied code and the user's identification against the database 40. Steps 72, 80, 84, 86 and 88 perform functions equivalent to the same numbered steps in FIG. 4 and, therefore, require no further description. The first difference with respect to FIG. 4 occurs when step 72 determines that the supplied code is not correct.

A negative answer in step 72 causes step 92 to be processed where it is determined whether the supplied code exists in the database 40 at some point after the next available code in the database. If not, processing continues at steps 74 and 76, as before, to report an error to the user. If, however, the supplied code does exist, an attempt is made to resynchronize the database 40 with the token's internal memory 32. At step 94, a request is sent to the user asking the user to provide the next available code from his or her token's internal memory 32. The user, in turn at step 96, has his or her token dispense a second code in the above-described manner and provides the code to the authentication system 34.

Upon receiving the next code from the user, the authentication system cross references the code against the database 40 at step 98. A query is made at step 100 to determine if, in the database 40, the second code immediately follows the code originally supplied by the user. If this is the case, resynchronization is possible, and all codes in the database 40 up to and including the second supplied code are removed from the database at step 102, and processing proceeds normally at step 84. If, however, resynchronization is not possible, processing continues at step 74 to report an error to the user. Suitable alterations to the method of FIG. 5 can be readily imagined to support polynomial transformations and other methods of tracking the next available code in the database 40, such as pointers for example.

As the available codes in the database 40 and internal memory 32 become depleted, alternate embodiments of methods exist for reminding a user that his or her token 10 is expiring and providing for replacement of the token. The status indicator 18 provides a visual indication to a user of the status of internal memory 32. Software in memory 30 is configured to update the status indicator 18 as each code is removed from internal memory 32. The status indicator 18, for example, serves as a bar graph depicting the remaining quantity of codes available from internal memory 32. On the remote side, the authentication system 34 is configured to monitor the quantity of codes available in the database 40 and can provide progressively more prominent warnings to a connected user as the database 40 becomes more depleted with each use. For replacement of an expired token 10, the authentication system 34 can optionally be configured to automatically trigger mailing of a new token 10 when the quantity of available codes in the database 40, and the token, is reduced to a predetermined threshold value.

Another method for reminding a user that his or her token 10 is expiring, that may be used in place of or supplemental to the above-described methods, is to provide one or more “dummy” codes at or near the end of the set of codes. For example, a code consisting of all nines could alert the user that replacement of the token in the near future is advisable. Also, the user could easily recognize that the code is a dummy number, and not one to be used for authentication purposes.

Although, in one suitable embodiment, the token 10 becomes inoperable when memory 32 becomes depleted, the authentication system 34 can be configured to perform reprogramming of an expired token 10. For example, the communications port 28 can be reactivated when internal memory 32 becomes depleted, allowing for reprogramming of the token 10 as previously described with reference to FIG. 2.

Receiving codes from the authentication system 34 and storing the numbers in internal memory 32 offers advantages in terms of reduced software complexity for the software in memory 30, and in terms of reducing computational power. The calculating of codes is relatively complex when compared to a simple method of selecting the next available code from a table of stored codes as described with reference to FIG. 3. The reduced computational complexity reduces the quantity of energy dissipated and provides the advantage of reduced battery or solar cell drain. The aforementioned simplified encryption function, or elimination of encryption, would further reduce battery or solar cell drain.

The reduced power requirements offered by the present inventive subject matter make it feasible for the power source 12 to be implemented in the form of a solar cell. Although the term “solar cell” has been used here, it is intended that the power source 12 receive sufficient light from interior lighting to provide adequate power to the token 10. If the power source 12 is implemented in the form of a battery, the reduced power requirements make it possible to utilize a smaller battery which aids in keeping the size of the token 10 substantially similar to a standard credit card. Alternately, the power source 12 can be implemented as a solar cell, with a battery backup providing power during periods of low light intensity.

It is intended that the present invention can be utilized in face-to-face transactions in addition to remote transactions over a network. For this purpose the magnetic transducer 26 has been provided on the token 10. A typical credit card, debit card or other such card includes a magnetic strip in the position of the simulated magnetic strip 24. On this strip, account information is recorded magnetically as a series of binary bits in either a 0 or a 1 state. This account information is read by scanners in face-to-face transactions such as typically occur during over-the-counter purchases in retail establishments. The token 10 and the magnetic transducer 26 can be configured to simulate the typical magnetic strip of a credit card, debit card or similar card, enabling the use of the token in magnetic strip readers.

Software in memory 30 can be configured so that, while the dispensed code 20 is being displayed, the magnetic transducer 26, in a timed sequence, changes its polarity in accordance with a string of zeroes and ones representing the dispensed code 20, and/or any other information such as a predetermined account number. The timing of the sequence of zeroes and ones is configured such that the generation of zeroes and ones at the transducer 26 occurs at substantially the same rate as the passage of zeroes and ones through a scanning device during a typical credit card transaction.

Although the transducer 26 is generating the equivalent of zeroes and ones at a typical scanning rate, the zeroes and ones do not appear spatially across the strip 24 as they do on a typical credit card. Instead, the associated magnetic fields generated by the transducer 26 are sufficiently large in magnitude that a typical magnetic strip reader can sense the zeroes and ones if the transducer 26 is only in the vicinity of the reader. Therefore, it is possible for a user to pass the token 10 through a magnetic strip reader in a manner similar to a standard credit card. Several methods of ensuring that the transducer 26 operate when in the vicinity of the magnetic strip reader currently exist.

One method of ensuring operation of the transducer 26 when in the vicinity of a magnetic strip reader is to configure one of the buttons 16 to act as a trigger switch for the transducer, such that the transducer does not operate unless the configured button is selected. This method would reduce the power requirements of the token 10, eliminating unnecessary operation of the transducer 26. Alternately, software in memory 30 can be configured to operate the transducer 26 while the dispensed code 20 is being displayed. The operation of the transducer 26 can be repeated at intervals, with a suitable delay between intervals, so that a magnetic strip reader can sense the series of zeroes and ones when the token 10 is passed through the reader.

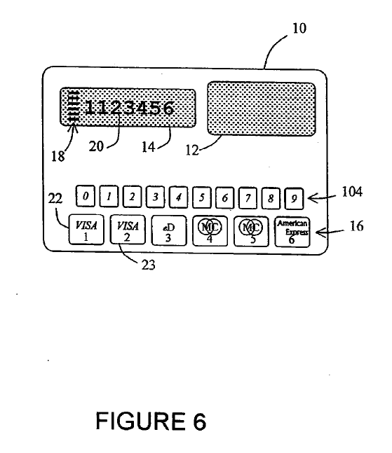

The embodiment as described in aforementioned FIGS. 1A and 1B can optionally be enhanced security-wise to include provision for a personal identification number (PIN) or other like password. A PIN can be programmed into the token 10 as part of the programming of the token as illustrated in FIG. 2. Once the token has been programmed with a PIN, upon selection of one of the buttons 16 by a user, the token requests that the programmed PIN be entered by the user and software 30 is configured to not dispense a code from memory 32 until the correct PIN has been entered. FIG. 6 shows an embodiment including a set of numeric keys 104 for a user to use when entering a PIN. Of course, alternately, other arrangements of keys are possible. For example, the number of buttons 16 available can be made sufficient for entering a PIN, wherein each of the buttons 16 is assigned a numeric value. In this case, after choosing an account by selecting one of the buttons 16, the user would select the correct combination of buttons comprising the programmed PIN, and the token 10 would return to an appropriate state thereafter, either dispensing a code if the entered PIN is correct, or waiting for another account selection if the PIN entered is incorrect.

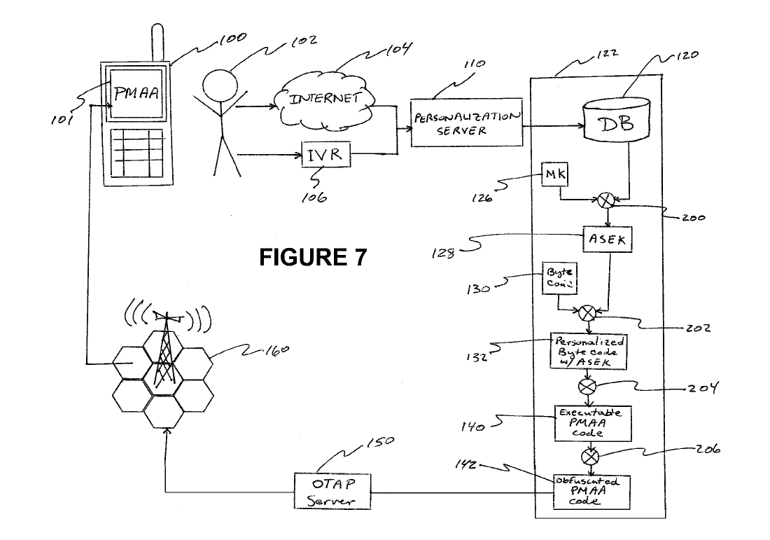

With reference to FIG. 7, in yet another embodiment, a mobile telecommunications device, e.g., such as a wireless or cellular telephone, or a wireless PDA, or other suitable mobile station (MS) 100 is programmed or otherwise provisioned with a personalized mobile authentication application (PMAA) 101 that generates one-time-use or limited-use authentication codes or passwords, e.g., on an as-requested basis. To so provision or otherwise equip or program the MS 100, as shown, a user 102 contacts a personalization server 110 or the like to enroll and/or request the PMAA 101. While only one user 102 and one MS 100 are shown for purposes of simplicity and clarity herein, it is to be appreciate that in practice typically multiple users and/or multiple MS are similarly situated and/or arranged.

In one suitable embodiment, the user 102 contacts the personalization server 110 via the Internet 104, for example, using an Internet enabled device with a suitable browser running thereon and navigating to a webpage or website provided by the server 110 to collect enrollment data or information. Optionally, the user 102 employs the MS 100 to connect with the personalization server 110, e.g., if the MS 100 is a suitably Internet enabled MS and/or otherwise appropriately equipped. Alternately, the user 102 employs a separate computer or other like device to connect with the server 110 over the Internet 104 in any customary manner. In another suitable embodiment, the user 102 contacts the personalization server 110 via an interactive voice response (IVR) system 106 or the like that collects the enrollment data or information and provides it to the server 110. Of course, optionally, any other suitable channel may be employed to collect the pertinent enrollment information.

Suitably, the enrollment data or information collected by the personalization server 110 includes relevant account information and/or optionally an identification of the MS 100 which is to be provisioned with the PMAA. The account information provided by the user 102 is optionally associated with a credit card or debit card or other payment instrument or financial account for which the user 102 desires to have authentication codes generated by the PMAA 101. For example, the collected account information optionally includes user information (such as name, address, telephone number, user ID, etc.), an account identifier (such as an account name or number), a card number or other payment instrument identifier, a card or payment instrument expiration date, a user selected or otherwise designated PIN or other password, etc. Optionally, the MS identifier provided with the enrollment data includes a telephone number assigned to the MS 100 or the SIM (Subscriber Identity Module) ID associated with the MS 110.

In one suitable embodiment, the collected account and/or enrollment information is stored and/or maintained in a file, database (DB), memory, look-up-table (LUT) or other like storage location along with other account and/or enrollment information from other users. For example, the personalization server 110 optionally generates and/or stores a record in a database 120 corresponding to each user, enrollment or account, such that each record includes the collected user, account and/or other enrollment information as the case may be. Suitably, as shown, the DB 120 resides within a hardware security module (HSM) 122, but it may alternately reside outside the HSM 122.

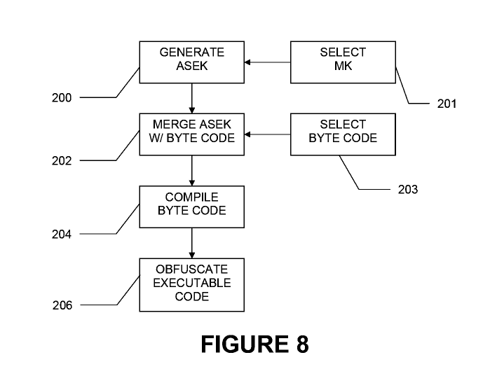

Suitably, the HSM 122 is an otherwise conventional HSM. However, the HSM 122 is programmed with a multifunction PMAA generation module or other like component or element provisioned within the HSM's secure memory area. With reference to FIG. 8, the multifunction module within the HSM 122 optionally operates to achieve the following functions: (i) generation of an application-specific encryption key (ASEK) (step 200); (ii) merging of the generated key with a selected byte code (step 202); (iii) compiling the byte code into machine or otherwise executable code for the PMAA (step 204); and, (iv) obfuscating the PMAA code (step 206). As described below, optionally, the process also includes selection an appropriate master key (MK) (step 201), and/or selection of an appropriate byte code file (step 203).

With reference to FIGS. 7 and 8, in one suitable embodiment, at initialization or otherwise during programming of the HSM 122, the HSM 122 is provisioned with a private or otherwise secret master key (MK) 126, e.g., implemented as an alphanumeric character string. Optionally, the HSM 122 is intended and/or designed to provide PMAAs that generate authentication codes in accordance with a variety of different code generating algorithms or protocols, e.g., which may optionally be prescribed by various different payment networks or other entities for various different authentication initiatives or other purposes. Accordingly, while only one MK 126 is shown in FIG. 7 for simplicity and clarity herein, it is to be appreciated that a plurality of similar MKs are optionally provisioned within the HSM 122, e.g., each MK being designated for and/or used in connection with a different code generating algorithm or protocol, or each MK being designated and/or used for a particular set of accounts or a particular group of users. Accordingly, when an application-specific encryption key (ASEK) 128 is generated, the appropriate MK is optionally selected (e.g., see step 201 in FIG. 8) based upon the user or account information being used to create the ASEK 128. For example, a first MK is optionally designated and/or used when the account information indicates that the PMAA 101 being created is associated with a first type of code generating protocol or algorithm, while a second MK is optionally designated and/or used when the account information indicates that the PMAA 101 being created is associated with a second type of code generating protocol or algorithm.

In one suitable embodiment, a separate ASEK 128 is generated or created for each account or enrollment record maintained in the DB 120. Suitably, to generate the ASEK 128 (e.g., which is optionally implemented as an alphanumeric character string), the selected MK 126 is first applied to and/or combined with selected user, account and/or enrollment information obtained from the DB 120. For example, optionally the account or card number combined with the expiration date are encrypted with the MK 126, and this encrypted code is then further encrypted with the corresponding PIN or password that was collected or otherwise established during the enrollment. Optionally, once created, the ASEK 128 is stored and/or otherwise maintained within the HSM 122, e.g., in the DB 120 along with the specific record or account and/or enrollment information used to create the ASEK 128.

Suitably, at initialization or otherwise during programming of the HSM 122, the HSM 122 is also provisioned with an object or file 130, e.g., implemented as byte code or other like non-executable code in a format intermediate between source code and machine or executable code. In one embodiment, to program or provide the HSM 122 with the byte code 130, corresponding source code is first generated and then compiled in the usual manner to produce the byte code 130 which is then loaded onto the HSM 122.

Again, optionally, the HSM 122 is intended and/or designed to provide PMAAs that generate authentication codes in accordance with a variety of different code generating algorithms or protocols. Accordingly, while only one byte code file 130 is shown for simplicity and clarity herein, it is to be appreciated that a plurality of similar byte code files are optionally provisioned within the HSM 122, e.g., each one being designated and/or used to execute a different code generating protocol or algorithm as the case may, or each one being designated and/or used for a particular set of accounts or a particular group of users. Accordingly, when the merging function is executed (e.g., as shown in step 202 of FIG. 8), the appropriate byte code file is optionally selected based upon the particular type of PMAA 101 being generated (e.g., as shown in step 203 of FIG. 8). For example, a first byte code file is optionally designated and/or used when the PMAA 101 being created is associated with a first type of code generating algorithm or protocol, while a second byte code file is optionally designated and/or used when the PMAA 101 being created is associated with a second type of code generating algorithm or protocol.

In one embodiment, once the ASEK 128 has been generated in step 200 and the appropriate byte code 130 has been selected (optionally, in step 203), the ASEK 128 is merged with and/or otherwise embedded in the byte code 130 in step 202 to produce a PMAA in byte code format as indicated by reference numeral 132. Suitably, the byte code 130 (and hence the resulting personalized code 132 also) optionally includes two parts. For example, a first part of the byte code 130 is optionally programmed to ultimately provide, control and/or administer a user interface (UI) and/or non-PMAA specific operations and/or functions associated with the PMAA 101 being generated, while a second part of the byte code 130 is programmed to generate the authentication codes ultimately dispensed by the particular PMAA 101 being created. Suitably, the second authorization-code-generating part is programmed or otherwise provisioned to execute a prescribed algorithm or function using the merged ASEK 128 to successively generate distinct one-time-use or limited-use authentication codes, e.g., on an as-requested basis. In one suitable embodiment, the prescribed algorithm optionally uses a counter or other like usage tracking device and the merged ASEK 128 to generate the distinct authentication codes. Optionally, the second part of the byte code 130 is programmed or provisioned so that the resulting PMAA 101 will execute or carry out a particular prescribed algorithm and/or encryption process to generate distinct authorization codes using the merged ASEK 128 and/or optional counter value in accordance with specifications which are, e.g., set forth by the particular type of payment network, and/or which are otherwise designated for the particular type of authentication initiative or authentication code generating protocol which is to be employed by the resulting PMAA 101. Therefore, the second parts of each different type of byte code 130 are programmed or provisioned accordingly.

Suitably, after having generated the personalized byte code 132 which has merged or embedded therein the ASEK 128, the resulting code 132 is compiled or otherwise transformed at step 204 into machine or otherwise executable code, i.e., the executable PMAA code 140. Optionally, to guard against reverse engineering or decompiling of the executable PMAA code 140, e.g., to uncover the ASEK 128, an obfuscation process is then executed at step 206 to created the obfuscated PMAA code 142.

In one embodiment, after the executable code has been obfuscated within the HSM 122, the PMAA 101 is sent or otherwise transferred to an Over-the-Air-Provisioning (OTAP) server 150 which is operatively connected to a wireless network 160 serving the MS 100 on which the PMAA 101 is to be installed or otherwise provisioned. Optionally, to complete deployment of the PMAA 101 to the MS 100, a short message service (SMS) message is sent to the MS 100 via the wireless network 160, e.g., using the telephone number of the MS 100 obtained during the enrollment process. Suitably, the SMS message informs the user 102 that the PMAA 101 is ready for download and optionally includes a hyperlink or other object that can be selected by the user 102 via the MS 100, thereby connecting the MS 100 to the OTAP server 150 or otherwise signaling the OTAP server 150 to install or otherwise provision the PMAA 101 on the MS 100 over the wireless network 160. Of course, optionally, the OTAP server 150 may simply deploy the PMAA 101 to the MS 100 automatically once the PMAA 101 has been received by the OTAP server 150.

In another embodiment, the PMAA 101 is held on a deployment platform and the MS 100 is provisioned with a suitable application that allows the user 102 to selectively access the platform over the wireless network 160 and download the PMAA 101 from the deployment platform to the MS 100 over the wireless network 160. In yet another embodiment, a Wireless Application Protocol (WAP) Push or other like function is used to deliver the PMAA 101 to the MS 100 over the wireless network 160. In still another embodiment, the PMAA 101 is optionally delivered and/or initially downloaded to a computer or other like device that is directly accessible by the user 102. Accordingly, the user 102 has the option of downloading the PMAA 101 to their MS 100 by a direct cable connected therebetween, or via a Bluetooth connection, or via Infrared transmission, or via some other suitable connection or delivery channel.

Suitably, once installed or otherwise provisioned in the MS 100, the PMAA 101 is stored or otherwise loaded in a memory or other location within the MS 100. For example, the PMAA 101 is optionally implemented as a J2ME (Java 2, Mobile Edition) application, BREW (Binary Runtime Environment for Wireless) application or other like application or program running within the MS 100. Alternately, the PMAA 101 is optionally stored or otherwise loaded onto a SIM card that is installed or otherwise equipped in the MS 100, e.g., with the PMAA 101 being implemented as a STK (SIM Toolkit) application or other like application or program.

Having provisioned the MS 100 with the PMAA 101, the user 102 is now free to selectively dispense authentication codes therefrom for use in connection with any one of a variety of different types of transactions, for example, on-line or Internet e-commerce transactions, face-to-face transactions, point-of-sale (POS) transactions, telephone transactions, on-line banking or financial transactions, etc. Suitably, the user 102 employs a UI that is displayed or otherwise presented on the MS 100 by the PMAA 101 to request an authentication code from the PMAA 101. In turn, the user 102 is optionally prompted to enter the PIN or password that was established during the enrollment process. Upon entering the PIN or password, the PMAA 101 dispense the next authentication code, e.g., which is displayed on the MS 100.

Suitably, the PMAA 101 employs a usage counter or other like device along with the embedded ASEK 128 and the entered PIN to generate a distinct one-time-use or limited-use authentication code which is dispensed. Recall that the PIN or password established during the enrollment process was also used originally to generate the ASEK 128 in the HSM 122. Accordingly, if the wrong PIN is entered into the PMAA 101, then the PMAA 101 will in turn generate an invalid authentication code.

Optionally, the dispensed code, along with relevant account or user information (e.g., an account or card number of other like payment instrument identifier or user ID) is communicated to a third party which desires to authenticate the identity of the user 102, such as a transaction or authentication processor (e.g., a merchant, a financial institution, one of their agents or proxies, etc.). Suitably, the dispensed authorization code and relevant account or user information is communicated to the third party via any suitable connection or in any desired manner. For example, the dispensed code and/or accompanying information is optionally communicated directly from the MS 100 via a Bluetooth connection, or via the Internet, or via IR transmission, or via an IVR system, or via a POS terminal, or it may be manually communicated or entered manually via another device. In short, it may be communicated in any suitable manner depending on the circumstances and/or the capabilities of the MS 100 and/or the party receiving the authorization code and/or the type of connection established therebetween.

In one suitable embodiment, the entered information (i.e., the dispensed authentication code and accompanying account or user information) communicated to the third party requesting or desiring authentication is in turn provided back to the HSM 122 or another similarly provisioned and/or programmed HSM. Optionally, from the entered information the HSM 122 essentially generates another PMAA and requests an authentication code therefrom. Assuming the entered account information and the PIN used to dispense the authentication code from the PMAA 101 are correct (i.e., are the same as was used to originally generate the PMAA 101), then the newly generated PMAA will essentially be a duplicate of the original and will dispense the same authentication code, provided the usage counters employed by the HSM 122 and the PMAA 101 are suitably synchronized. Accordingly, the entered authentication code is compared to the authentication code dispensed by the duplicate PMAA. Generally, a match indicates a correct or valid authentication code has been entered, and no match indicates that an incorrect or invalid authentication code has been entered.

Suitably, the counter used by the PMAA 101 is initially synchronized to the counter employed in the HSM 122. Therefore, if someone attempts to reuse an old code (e.g., a code that was already previously used), then the current counter employed by the otherwise duplicate PMAA generated to validate the entered authorization code will be effectively out of sync, and the entered old code will not match the newly generated coded dispensed thereby. In this manner, authentication codes dispensed by the PMAA 101 are limit to a single use, or optionally a relatively small finite number of uses. Of course, optionally, a method similar to the one described with reference to FIG. 5, may be employed to re-synchronize the counters if they are accidentally thrown out of synchronization.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for provisioning a mobile device with a personalized authorization code generating application, said method comprising:
(a) collecting user information and a password;
(b) generating an application specific encryption key from the collected user information and the password;
(c) embedding the generated application specific encryption key in a software code provisioned to generate authorization codes using the application specific encryption key in accordance with a prescribed algorithm, said software code with the application specific encryption key embedded therein comprising the personalized authorization code generating application; and,
(d) delivering the personalized authorization code generating application to the mobile device.

2. The method of claim 1, wherein said software code in step (c) is in a non-executable format and said method further comprises:
(e) compiling the software code having the application specific encryption key embedded therein into an executable format prior to executing step (d).

3. The method of claim 2, further comprising:
(f) obfuscating the executable format of the software code having the application specific encryption key embedded therein prior to executing step (d).

4. The method of claim 3, wherein said in steps (b), (c), (e) and (f) are executed within a hardware security module.

5. The method of claim 1, wherein said user information comprises one or more of a card number, a card expiration data, an account number, a user name and a user ID.

6. The method of claim 1, wherein said password comprises a personal identification number.

7. The method of claim 1, wherein step (b) further comprises.
selecting a master key from a plurality of different master keys; and,
using the selected master key to generate the application specific encryption key.

8. The method of claim 7, wherein step (c) further comprises.
selecting the software code in which the application specific encryption key is embedded from a plurality of different software codes.

9. The method of claim 1, wherein step (d) comprises.
forwarding the personalized authentication code generating application to an over-the-air provisioning server that is operatively connected to a wireless telecommunications network serving the mobile device; and,
provisioning the mobile device with the personalized authentication code generating application via the wireless telecommunications network.

10. The method of claim 1, further comprising.
sending a short message service (SMS) message to the mobile device, said SMS message containing a link that when selected initiates execution of step (d).

11. The method of claim 1, wherein step (d) comprises.
forwarding the personalized authentication code generating application to an application delivery platform which is selectively accessible by the mobile device to download the personalized authentication code generating application.

12. The method of claim 1, wherein the personalized authentication code generating device is delivered to the mobile device using one of a Bluetooth connection, an infrared connection, an Internet connection or a direct cable connection.

13. The method of claim 1, wherein the mobile device is one of a mobile telephone or a wireless personal digital assistant.

14. The method of claim 1, wherein the personalized authentication code generating application generates one-time-use authentication codes upon request, each of said one-time-use authentication codes being valid for a single use.

15. The method of claim 1, wherein the personalized authentication code generating application is delivered to the mobile device so as to reside in memory on the mobile device as one of a Java 2, Mobile Edition (J2ME) application or a Binary Runtime Environment of Wireless (BREW) application.

16. The method of claim 1, wherein the personalized authentication code generating application is delivered to the mobile device so as to reside on a Subscriber Identity Module (SIM) card equipped in the mobile device as a SIM Toolkit (STK) application.

17. A system for provisioning a mobile device with a personalized authorization code generating application, said system comprising:
data collection means for collecting user information and a password;
key generation means for generating an application specific encryption key from the collected user information and the password;
merging means for embedding the generated application specific encryption key in a software code provisioned to generate authorization codes using the application specific encryption key in accordance with a prescribed algorithm, said software code with the application specific encryption key embedded therein comprising the personalized authorization code generating application; and,
delivery means for delivering the personalized authorization code generating application to the mobile device.

18. The system of claim 17, wherein the key generation means and merging means are implemented within a hardware security module.

19. The system of claim 18, wherein the delivery means includes an over-the-air provisioning server operatively connected to a wireless telecommunications network serving the mobile station.
